(19) United States
(12) Patent Application Publication
(10) Pub. No.: US 2005/0007946 A1
(43) Pub. Date: Jan. 13, 2005

(54) Multi-carrier transmission

(76) Inventor: Andre Noll Barreto, Rio de Janeiro (BR)

Correspondence Address: Louis P. Herzberg;IBM Corporation, Intellectual Property Law Dept., P.O. Box 218, Yorktown Heights, NY, 10598, US

(21) Appl. No.: 10/867,426

(22) Filed: Jun. 14, 2004

Related U.S. Application Data
(63) Continuation-in-part of application No. PCT/IB02/04843, filed on Nov. 21, 2002.

(30) Foreign Application Priority Data
Dec. 17, 2001 (EP) 01811232.6

(51) Int. Cl. H04J 1/00; H04J 11/00

(52) U.S. Cl. 370/203; 370/343

(57) ABSTRACT

Methods, systems and apparatus for multi-carrier transmission of data. An example of a method includes the steps of: providing a stream of data, encoding the stream of data to create a plurality of complex values, assigning each of the plurality of complex values to one of a plurality of sub-channels which form one of two or more channels, assigning a separate value to each of the plurality of sub-channels, multiplying each of the plurality of sub-channels with the assigned separate value to generate a multiplied value for each of the plurality of sub-channels, modulating the multiplied value of each of the plurality of sub-channels to a sub-carrier to generate a modulated signal for each of the two or more channels, and simultaneously transmitting the modulated signal of each of the two or more channels.

### PRIORITY AND CROSS-REFERENCE

This application is a continuation-in-part of International Patent Application, PCT Serial No. PCT/1B02/04843 filed Nov. 21, 2002. This application claims priority from European application No. EP018112326, filed Dec. 17, 2001, and the International Patent Application, PCT Serial No. PCT/1B02/04843 filed Nov. 21, 2002. This application is cross-referenced with the above mentioned priority documents, and with International Publication No. WO03/053020 which are included herein by reference in entirety for all purposes.

### TECHNICAL FIELD

The present invention is related to a method and apparatus for multi-carrier transmission of data. In particular, the invention relates to an efficient transmission diversity scheme which is particularly suitable for wireless transmission.

### BACKGROUND OF THE INVENTION

Multi-carrier modulation has been proposed for use in wireless environments, both for broadcast applications, as in the European Digital Video Broadcasting (DVB) standards, and for high-rate wireless Local Area Networks (W-LAN), as in the North-American IEEE 802.11a and in the European HIPERLAN-2 standards, which all rely on coded orthogonal frequency division multiplexing (OFDM). These standards support high data rate wireless transmission up to 54 Mbps.

The idea behind OFDM is to split the incoming data stream into several parallel streams of lower rate (and hence longer symbol period Tₛ) and transmit each of them in a different sub-channel. These are transmitted using different sub-carriers which are spaced 1/Tₛ apart. With this choice of sub-carrier spacing the sub-channels are orthogonal when appropriately sampled and spectral overlapping of the sub-channels is allowed, maximizing the spectral efficiency of the transmission.

An advantage of OFDM is its resilience against inter-symbol interference (ISI) caused by the multipath propagation common in the wireless channel. This resilience can be achieved through a cyclic extension of the signal by a guard interval, which should be longer than the maximum delay of the channel.

Broadband wireless systems are usually characterized by frequency selective fading, i.e. different fading is observed at different frequencies. In coded OFDM the data bits are coded across the different sub-carriers, which offers some protection against frequency selective channels. This protection is however limited since neighboring frequencies are likely to be highly correlated, so that deep fades tend to affect several sub-channels.

One alternative to combat fading is to use multiple antennas to obtain space diversity. In order to obtain sufficient diversity it is necessary that the channels at different antennas have a low correlation, which means that they should be sufficiently far apart from each other. Besides that, each antenna requires a separate radio front end, thus increasing the transceiver costs. These problems make the use of multiple antennas most likely at the base stations only, and, hence, in the downlink diversity techniques have to be employed at the transmitter side.

High-speed W-LANs systems are targeted at static or slow-moving applications in an indoor environment. For this type of use the channel changes very slowly, for instance at walking speeds (1 m/s) with carrier frequency f_{c}=5 GHz the coherence time is T_{c}=25 ms, corresponding to more than 12 MAC frames of 2 ms in HIPERLAN/2. With static (portable) terminals fades may last over several hundreds of milliseconds. For data applications Automatic Repeat Request (ARQ) schemes or simple packet retransmissions may be used to guarantee low packet loss and nearly error-free transmission. Under the channel conditions mentioned above however, a packet may have to be retransmitted many times or with a large delay between retransmissions until it is received with no errors, thus reducing the system throughput and increasing the transmission delay.

A so-called clustered OFDM system has been suggested in U.S. Pat. No. 5,914,933 in which a different subset of contiguous sub-carriers is assigned to each antenna. This system has disadvantages in that little frequency diversity can be obtained as adjacent sub-carriers are transmitted from the same antenna and are thus correlated.

U.S. Pat. No. 6,005,876 describes a high-speed wireless transmission system wherein the subsets are such that the sub-carriers are evenly spread across the whole bandwidth. This can be contemplated as antenna-hopping in the frequency domain. The system has disadvantages in view of throughput with repeating schemes. The approach represents a progress in terms of frequency diversity, but little can be gained in terms of time diversity with ARQ, even if the sub-carriers are changed.

From the above it becomes clear that an efficient transmission diversity scheme is highly desirable which can be applied to existing standards, such as the OFDM-based standards. Moreover, a reduction in the error rate and therefore a higher data throughput should be achievable in order to have an improvement in the performance of the transmission and more reliability.

### SUMMARY AND ADVANTAGES OF THE INVENTION

Therefore, one aspect of the present invention is to provide methods, systems and apparatus for multi-carrier transmission of data. One method comprises the steps of: providing a stream of data; encoding the stream of data to create a plurality of complex values; assigning each of the plurality of complex values to one of a plurality of sub-channels which form one of two or more channels; assigning a separate value to each of the plurality of sub-channels; multiplying each of the plurality of sub-channels with the assigned separate value to generate a multiplied value for each of the plurality of sub-channels; modulating the multiplied value of each of the plurality of sub-channels to a sub-carrier to generate a modulated signal for each of the two or more channels; and simultaneously transmitting the modulated signal of each of the two or more channels.

The method provides an efficient transmission diversity scheme which can be applied to existing standards with no or few modifications in the standards, such as the OFDM-based W-LAN standards, as it has low additional complexity if multiple antennas are employed anyway. Moreover, a substantial reduction in the error rate can be achieved. Therefore a higher data throughput is achievable. An improvement in the performance of the transmission and more reliability can therefore be provided.

In accordance with a second aspect of the present invention there is provided an apparatus for multi-carrier transmission of data comprising: an encoder unit that receives a stream of data and creates a plurality of complex values; a de-multiplexer for assigning each of the plurality of complex values to one of a plurality of sub-channels which form one of two or more channels; a multiplication unit for multiplying each of the plurality of sub-channels with a separate value to generate a multiplied value for each of the plurality of sub-channels; a modulator for modulating the multiplied value of each of the plurality of sub-channels to a sub-carrier to generate a modulated signal for each of the two or more channels; and a transmitter for simultaneously transmitting the modulated signal via a transmission antenna, each of the two or more channels has its assigned transmission antenna.

### DESCRIPTION OF THE DRAWINGS

Embodiments of the invention are described in detail below, by way of example only, with reference to the following schematic drawings, in which:

FIG. 1 shows a schematic illustration of a multi-carrier transmission apparatus according to the present invention;

FIG. 2 shows a schematic illustration of the multi-carrier transmission apparatus in a more abstract way;

FIG. 3 shows a schematic illustration of a corresponding receiver; and

FIG. 4 shows a diagram displaying the data throughput with different transmission schemes.

### DETAILED DESCRIPTION OF THE INVENTION

The present invention provides methods, systems and apparatus for multi-carrier transmission of data. A method includes the steps of: providing a stream of data; encoding the stream of data to create a plurality of complex values; assigning each of the plurality of complex values to one of a plurality of sub-channels which form one of two or more channels; assigning a separate value to each of the plurality of sub-channels; multiplying each of the plurality of sub-channels with the assigned separate value to generate a multiplied value for each of the plurality of sub-channels; modulating the multiplied value of each of the plurality of sub-channels to a sub-carrier to generate a modulated signal for each of the two or more channels; and simultaneously transmitting the modulated signal of each of the two or more channels.

The method provides an efficient transmission diversity scheme which can be applied to existing standards with no or few modifications in the standards, such as the OFDM-based W-LAN standards, as it has low additional complexity if multiple antennas are employed anyway. Moreover, a substantial reduction in the error rate can be achieved. Therefore a higher data throughput is achievable. An improvement in the performance of the transmission and more reliability can therefore be provided.

The method provides basically a frequency domain predistortion and makes use of multiple transmit antennas to increase the frequency diversity of a multi-carrier system. It can be also employed to provide a system with time diversity, which can be exploited by error control functions (e.g. Automatic Repeat Request (ARQ)) of upper layers to increase the data throughput.

The step of multiplying with the assigned separate value can provide a phase shift and/or an amplitude change in the sub-carrier. By doing that, the autocorrelation in the frequency domain becomes smaller. Moreover, the applied code can be used more efficiently. It can be advantageous if the difference of the phase shift from one to the next sub-carrier is constant. This effects a delay in the channel. At a receiver's side, the channel estimation can therefore be performed more efficiently.

The step of assigning the separate value to each of the plurality of sub-channels can include providing random variables for use in the separate value. Using random variables increases the frequency selectivity in the channel and also the used code becomes more efficient. The step of assigning the separate value to each of the plurality of sub-channels can include providing a constant amplitude value with different phase values for use in the separate value. This is advantageous because the power allocation among the sub-carriers is maintained, with no noticeable effect in the transmission performance.

The different phase values can belong to a set of possible fixed values, because then the complex multiplication can be simplified. The stream of data comprises packets, and for each packet one separate value is applied, i.e. the separate value is different for each packet. By doing so a defined assignment of separate values to the respective packets can be achieved, which leads to time diversity.

It is advantageous, when knowing a channel gain of one of the plurality of sub-channels, to change a phase value of the separate value such that the separate value provides a phase shift corresponding to an inverse of the phase of the one of the plurality of sub-channels, because then the advantage occurs that the signals from different antennas are receivable coherently. When the channel gain is known, i.e. the channel estimation was successful, it is further advantageous to adapt an amplitude value of the separate value such that the amplitude value is proportional to the amplitude of the one of the plurality of sub-channels, because then the advantage occurs that the signals are receivable coherently and the signal-to noise ratio (SNR) can be maximized.

The step of modulating can comprise an OFDM modulation. This shows that the proposed scheme can be applied to standard modulation techniques.

The present invention also provides an apparatus for multi-carrier transmission of data comprising: an encoder unit that receives a stream of data and creates a plurality of complex values; a de-multiplexer for assigning each of the plurality of complex values to one of a plurality of sub-channels which form one of two or more channels; a multiplication unit for multiplying each of the plurality of sub-channels with a separate value to generate a multiplied value for each of the plurality of sub-channels; a modulator for modulating the multiplied value of each of the plurality of sub-channels to a sub-carrier to generate a modulated signal for each of the two or more channels; and a transmitter for simultaneously transmitting the modulated signal via a transmission antenna, each of the two or more channels has its assigned transmission antenna. Embodiments of this aspect of the invention therefore employ similar principles as mentioned above.

Although the present invention is applicable in a broad variety of multi-carrier transmission applications it will be described with the focus put on an application to wireless systems, i.e. Wireless Local Area Networks (W-LAN), using orthogonal frequency division multiplexing (OFDM) as employed in the W-LAN standards IEEE 802.11a and HIPERLAN-2. Before embodiments of the present invention are described, some basics, in accordance with the present invention, are addressed.

In general, the proposed transmit diversity scheme applies a multiplication of symbols, also referred to as complex values xₖ(i), to be transmitted at a k-th sub-channel on the respective sub-carrier, at an antenna Aₗ by a coefficient, also referred to as separate values a_{l,k}. The expression i corresponds to the i-th OFDM symbol. Each separate value a_{l,k} comprises an amplitude value a_{l,k} and a phase value φ_{l,k}, as described in more detail below. The separate values a_{l,k} can be considered as values which are complex. Best results can be achieved with systems having at least two antennas Aₗ, which means having at least two channels l. Considering a single receive antenna 52, as shown in FIG. 3, the received signal after a Fast Fourier Transformation (FFT) at the k-th sub-channel will be
rₖ(i)=h_{eq,k}xₖ(i),
where h_{eq,k} is the gain of an equivalent channel composed by all channels l, also referred to as equivalent channel gain h_{eq,k}.

It is given by
h_{eq,k}=Σₗa_{l,k}h_{l,k},
where h_{l,k} is the channel gain for the l-th antenna Aₗ and the k-th sub-channel. The number of transmit antennas Aₗ and the choice of the separate values a_{l,k} are transparent to a receiver and no extra signaling is needed. The receiver receives the transmitted signal xₖ(i) modified by the equivalent channel gain h_{eq,k} as if it would have been transmitted from a single antenna A. Thus, the receiver sees just the equivalent channel gain h_{eq,k} and if the separate values a_{l,k} are also applied to a training preamble, the equivalent channel gain h_{eq,k} can be obtained by conventional channel estimation techniques, as they are known in the art.

In order to provide time diversity the separate values a_{l,k} should change at each packet. There are several different ways to choose the separate values a_{l,k}(n) corresponding to the n-th packet. In a first example, it is proposed that they have all the amplitude a_{l,k} and random phases, by making:
a_{l,k}(n)=a_{l,k} exp(jΦ_{l,k}(n)),
where the phase value Φ_{l,k}(n) comprises independent uniform random variables in the interval (0,2π). If the same transmit power as in a single-antenna system is desired, the amplitude can be chosen as a_{l,k}=\sqrt{(L)}, with L being the total number of antennas Aₗ. It can be shown that the frequency diversity of the system increases with this choice, i.e., the correlation between channel gains of different sub-channels k decreases compared to a single-antenna system. This results in a substantial reduction in the error rate. Alternatively, in a second example, the amplitudes a_{l,k} can be chosen randomly. The performance using the random-phase approach according to the first example is similar to the second example.

As already mentioned, the time-variant nature of the proposed transmit diversity scheme provides time diversity when packet repetition schemes like Automatic Repeat Request (ARQ) are employed. This technique can be used with packet combining at the receiver to achieve further performance gains. Packets received with error should not be thrown away. They can instead be stored and combined with later repeated versions of the same packet, ideally employing maximum ratio combining. The association of packet combining with the transmit diversity scheme can increase the throughput of OFDM wireless systems. This results in increased capacity and reduced transmission delay and can also be employed in existing systems.

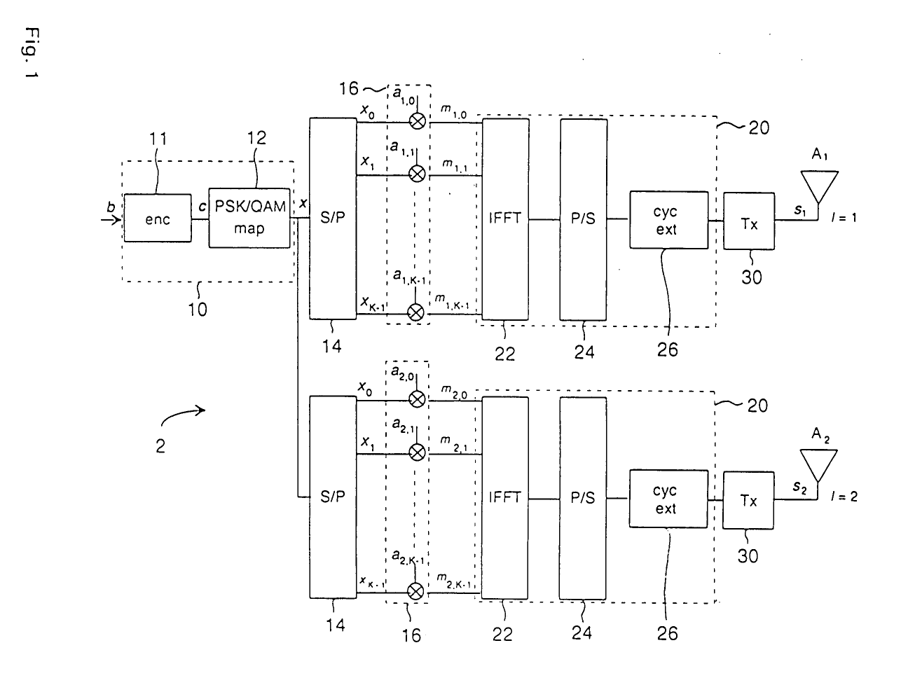

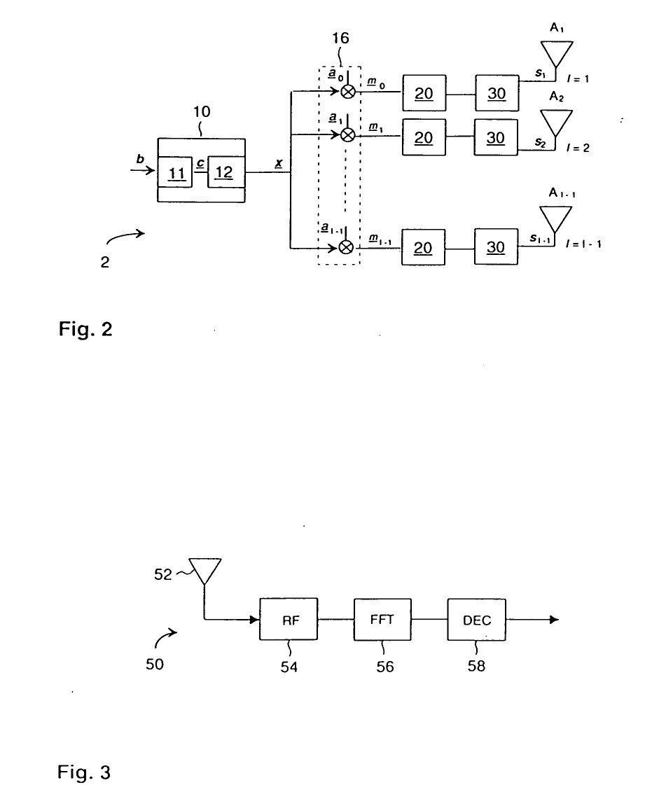

FIG. 1. shows a schematic illustration of a multi-carrier transmission apparatus 2. An encoder unit 10 receives at its input a stream of data b and provides at its output a plurality of complex values x. The encoder unit 10 is also contemplated as bit interleaved coded modulation (BICM) unit 10 which here comprises an encoder 11 and a mapper 12 that either applies a Phase Shift Keying (PSK) or a Quadrature Amplitude Modulation (QAM). An interleaver unit between the encoder 11 and the mapper 12 is not shown for simplicity reasons. The output of the encoder unit 10 is connected to two de-multiplexers 14, where each corresponds to a channel l. The number of channels l can be higher than two as indicated in FIG. 2. In the following only one channel is regarded as the functions of the units are identical. The de-multiplexer 14 assigns each of the plurality of complex values xₖ to one of a plurality of sub-channels k. A multiplication unit 16 is connected with each of the plurality of sub-channels k. A separate value a_{l,k} is provided to the multiplication unit 16 and designable as described above. In each channel l the plurality of sub-channels k is connected to a modulator 20. The modulator 20 comprises an Inverse Fast Fourier Transformation (IFFT) unit 22 which is connected to a multiplexer 24. The multiplexer 24 serializes the signal stream which it receives from the Inverse Fast Fourier Transformation (IFFT) unit 22. The serialized signal stream is fed to a cyclic extension unit 26. The output of the cyclic extension unit 26 which is also the output of the modulator 20 is fed to a transmitter 30. Such a transmitter 30 usually comprises a transmit or TX filter and an RF (radio frequency) front end, which are not shown for simplicity. A modulated signal sₗ is sendable via an transmission antenna Aₗ. Each channel l has its transmission antenna A₁, A₂.

The multi-carrier transmission apparatus 2 operates as follows. The stream of data b is encoded by the encoder unit 10 to a plurality of complex values x. Each of the plurality of complex values xₖ is assigned to one of the plurality of sub-channels k. Further, to each of the plurality of sub-channels k one separate value a_{l,k} is assigned. Each separate value a_{l,k} can be created as described above while there are several variation possibilities. Also, the separate values a_{l,k} can be adapted to the channel conditions. As indicated in FIG. 1, each of the plurality of sub-channels k is multiplied with the assigned separate value a_{l,k} to generate a multiplied value m_{l,k} for each of the plurality of sub-channels k. This is shown by the multiplication symbol within the multiplication unit 16. In the modulator 20, the multiplied values m_{l,k} of each of the plurality of sub-channels k are fed to the Inverse Fast Fourier Transformation (IFFT) unit 22. After serializing with the multiplexer 24 and a processing with the cyclic extension unit 26 the modulated signal sₗ is provided to the transmitter 30. The modulated signal sₗ of each channel l is transmitted simultaneously via the transmission antennas A₁, A₂, which are assigned to the respective channel l.

FIG. 2 shows a schematic illustration of a further embodiment of the multi-carrier transmission apparatus 2 having multiple channels l. Vectors are used to represent the data, as indicated by the underlined characters. The general structure and functionality are similar to that of FIG. 1. The same reference numerals are used to denote same or like elements. The stream of data b(n), also referred to as input data sequence, of length N_{pack} is coded into N_{pack, c} =N_{pack}/R_{c} code bits, with R_{c} the code rate, using the encoder 11, and these are divided into ┌N_{pack, c}/N_{c}┐ blocks of N_{c} bits c(i), corresponding to the i-th OFDM symbol. These are then mapped by using the mapper 12 to K_{d}=N_{c}/log₂ (M) QAM or Quadrature Phase Shift Keying (QPSK) symbols, also referred to as complex value vectors x(i), where M is a constellation size. To simplify the notation, the time index i is dropped whilst a single OFDM symbol or complex value vector x is considered. The complex value vectors x correspond to the OFDM signal in the frequency domain. Kₚ pilot and K_{z} zero sub-carriers relating to the respective sub-channels are introduced and the signal goes through a K-point Inverse Fast Fourier transformation (IDFT), with K=K_{d}+Kₚ+K_{z}, as implemented in the modulator 20 (not shown). To the time-domain signal thus obtained one adds a cyclic prefix of G samples, as performed in the cyclic extension unit 26 (here not shown) that is also comprised in the modulator 20, in order to eliminate multipath interference up to a delay spread of T_{G}=GTₛ, where Tₛ is the sampling interval. The resulting modulated signal sₗ is filtered, converted to radio frequency by using the transmitter 30 and transmitted via the transmission antenna Aₗ through a multipath channel.

The multi-carrier transmission apparatus 2 uses in the frequency domain a predistortion as indicated by the multiplying symbols at each sub-channel k in the multiplication unit 16. The predistortion is performed by multiplying the elements of the complex value vector x by the elements of the separate value vector aₗ. The transmitted signal at the k-th sub-carrier and l-th antenna Aₗ is
x_{l,k}=a_{l,k} xₖ.

A receiver performs the reverse operations. The received signal is filtered, converted to baseband and sampled at a rate 1/Tₛ. The cyclic extension is removed and a discrete Fourier transformation (DFT) performed. The zero and pilot sub-carriers are removed and the signal at the k-th sub-channel after this operation is
yₖ=hₖxₖ+vₖ,
where hₖ is the equivalent channel gain and vₖ a complex noise component with variance N₀.

Based on channel estimates ĥₖ one equalize the received signal to obtain the signal estimates

$${\hat{x}}_{k} = \frac{{y}_{k}}{{\hat{h}}_{k}}$$

With the symbol and channel vector estimates \hat{x} and ĥ respectively one can obtain the log-likelihood ratio of the code bits ĉ, which can be decoded for instance using a soft-input Viterbi decoder.

A known preamble is sent before each data packet to allow receiver synchronization and channel estimation, as well as an initial acquisition of the frequency offset. The preamble is also modified with the separate value a_{l,k}. Since OFDM systems are very sensitive to frequency estimation errors, a number of pilot sub-carriers are introduced to improve the estimation and correction of the frequency offset during a packet. IEEE 802.11a supports variable bit rates, which can be achieved through different modulation schemes and different coding rates.

At the receiver the frequency-domain signal at each receive antenna can be multiplied element-wise by a vector and the signal from all the receive antennas is added up together. Weight vectors can be chosen according to a combining scheme, like maximum ratio combining for instance for a maximization of the signal-to-noise ratio (SNR).

FIG. 3 shows a schematic illustration of a receiver 50 as applicable in connection with the multi-carrier transmission apparatus 2 shown in FIGS. 1 and 2. The receiver 50 comprises a single receive antenna 52, demodulator units 54 and 56, and a decoder 58 which are connected in a line. The demodulator units 54 and 56 demodulate a received signal, e.g. an OFDM signal, by using known techniques such as coherent or differential detection. The decoder 58 is used as an error correction decoder. It is understood that multiple receivers 50 can be applied for the reception of transmitted signals sₗ. The pre-distortion is in principle transparent to the receiver 50, which does not have to know whether transmit diversity was employed and simply tries to estimate the equivalent channel gain h_{eq,k}.

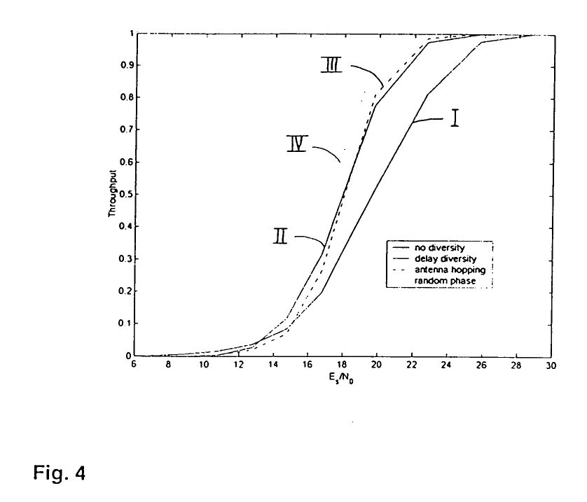

The performance improvement with the proposed transmit diversity scheme using random phases is displayed in FIG. 4. A system with four transmit antennas was considered and the proposed transmit diversity scheme, as depicted with curve IV, was compared both with a single-antenna system, shown as curve I, and with known transmit diversity schemes, curves II and III. In detail, curve II shows a delay diversity scheme whilst curve III shows an antenna hopping in the frequency domain. The performance was measured in terms of throughput, which is defined as the number of correctly received packets divided by the total number of transmitted packets. Automatic Repeat Request (ARQ) has been considered in all four cases. From the four graphs it becomes clear that curve IV shows the best performance.

Any disclosed embodiment may be combined with one or several of the other embodiments shown and/or described. This is also possible for one or more features of the embodiments.

The present invention can be realized in hardware, software, or a combination of hardware and software. A visualization tool according to the present invention can be realized in a centralized fashion in one computer system, or in a distributed fashion where different elements are spread across several interconnected computer systems. Any kind of computer system—or other apparatus adapted for carrying out the methods and/or functions described herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context include any expression, in any language, code or notation, of a set of instructions intended to cause a system having an information processing capability to perform a particular function either directly or after conversion to another language, code or notation, and/or reproduction in a different material form.

Thus the invention includes an article of manufacture which comprises a computer usable medium having computer readable program code means embodied therein for causing a function described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a a function described above. The computer readable program code means in the computer program product comprising computer readable program code means for causing a computer to effect one or more functions of this invention. Furthermore, the present invention may be implemented as a program storage device readable by machine, tangibly embodying a program of instructions executable by the machine to perform method steps for causing one or more functions of this invention.

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

1. A method for multi-carrier transmission of data comprising the steps of:
providing a stream of data;
encoding the stream of data to create a plurality of complex values;
assigning each of the plurality of complex values to one of a plurality of sub-channels which forms one of two or more channels;
assigning a separate value to each of the plurality of sub-channels, wherein random variables are provided for use in the separate value;
multiplying each of the plurality of complex values with the assigned separate value to generate a multiplied value for each of the plurality of sub-channels;
modulating the multiplied value of each of the plurality of sub-channels to a different sub-carrier by using an inverse fast Fourier transformation to generate a modulated signal for each of the two or more channels; and
simultaneously transmitting the modulated signal of each of the two or more channels.

2. A method according to claim 1, wherein the step of multiplying with the assigned separate value provides a phase shift and/or an amplitude change in the sub-carrier.

3. A method according to claim 2, wherein the difference of the phase shift from one to the next sub-carrier is constant.

4. A method according to claim 1, wherein for the random variables in the separate value variables in an interval (0,2π) are used.

5. A method according to claim 1, wherein the step of assigning the separate value to each of the plurality of sub-channels comprises providing a constant amplitude value with different phase values for use in the separate value.

6. A method according to claim 1, further comprising, when knowing a channel gain of one of the plurality of sub-channels, changing a phase value of the separate value such that the separate value provides a phase shift corresponding to an inverse of the phase of the one of the plurality of sub-channels.

7. A method according to claim 6 further comprising adapting an amplitude value of the separate value such that the amplitude value is proportional to the amplitude of the one of the plurality of sub-channels.

8. A method according to claim 1, wherein the step of modulating comprises an OFDM modulation.

9. A method according to claim 1, wherein the stream of data comprises packets and for each packet one separate value is applied.

10. An apparatus for multi-carrier transmission of data comprising:
an encoder unit that receives a stream of data and creates a plurality of complex values;
a de-multiplexer for assigning each of the plurality of complex values to one of a plurality of sub-channels which forms one of two or more channels;
a multiplication unit for multiplying each of the plurality of complex values with a separate value to generate a multiplied value for each of the plurality of sub-channels, wherein random variables are provided for use in the separate value;
a modulator for modulating the multiplied value of each of the plurality of sub-channels to a different sub-carrier under use of an inverse fast Fourier transformation to generate a modulated signal for each of the two or more channels; and
a transmitter for simultaneously transmitting modulated signals via an transmission antenna, each of the two or more channels has its assigned transmission antenna.

11. A program storage device readable by machine, tangibly embodying a program of instructions executable by the machine to perform method steps for multi-carrier transmission of data, said method steps comprising the steps of claim 1.

12. An article of manufacture comprising a computer usable medium having computer readable program code means embodied therein for causing multi-carrier transmission of data, the computer readable program code means in said article of manufacture comprising computer readable program code means for causing a computer to effect the steps of:
providing a stream of data;
encoding the stream of data to create a plurality of complex values;
assigning each of the plurality of complex values to one of a plurality of sub-channels which forms one of two or more channels;
assigning a separate value to each of the plurality of sub-channels, wherein random variables are provided for use in the separate value;
multiplying each of the plurality of complex values with the assigned separate value to generate a multiplied value for each of the plurality of sub-channels;
modulating the multiplied value of each of the plurality of sub-channels to a different sub-carrier by using an inverse fast Fourier transformation to generate a modulated signal for each of the two or more channels; and
simultaneously transmitting the modulated signal of each of the two or more channels.

13. An article of manufacture as recited in claim 12, the computer readable program code means in said article of manufacture, wherein the step of assigning the separate value to each of the plurality of sub-channels comprises providing a constant amplitude value with different phase values for use in the separate value.

14. An article of manufacture as recited in claim 12, the computer readable program code means in said article of manufacture further comprising computer readable program code means for causing a computer to effect: when knowing a channel gain of one of the plurality of sub-channels, changing a phase value of the separate value such that the separate value provides a phase shift corresponding to an inverse of the phase of the one of the plurality of sub-channels.

15. An article of manufacture as recited in claim 14, the computer readable program code means in said article of manufacture further comprising computer readable program code means for causing a computer to effect adapting an amplitude value of the separate value such that the amplitude value is proportional to the amplitude of the one of the plurality of sub-channels.

16. An article of manufacture as recited in claim 12, the computer readable program code means in said article of manufacture further comprising computer readable program code means for causing a computer to effect, wherein the stream of data comprises packets and for each packet one separate value is applied.

17. A computer program product comprising a computer usable medium having computer readable program code means embodied therein for causing multi-carrier transmission of data, the computer readable program code means in said computer program product comprising computer readable program code means for causing a computer to effect the functions of:
an encoder unit that receives a stream of data and creates a plurality of complex values;
a de-multiplexer for assigning each of the plurality of complex values to one of a plurality of sub-channels which forms one of two or more channels;
a multiplication unit for multiplying each of the plurality of complex values with a separate value to generate a multiplied value for each of the plurality of sub-channels, wherein random variables are provided for use in the separate value;
a modulator for modulating the multiplied value of each of the plurality of sub-channels to a different sub-carrier under use of an inverse fast Fourier transformation to generate a modulated signal for each of the two or more channels; and
a transmitter for simultaneously transmitting the modulated signal via an transmission antenna, each of the two or more channels has its assigned transmission antenna.

18. An method for multi-carrier transmission of data comprising the steps of:
providing a stream of data;
encoding the stream of data to create a plurality of complex values;
assigning each of the plurality of complex values to one of a plurality of sub-channels which form one of two or more channels;
assigning a separate value to each of the plurality of sub-channels;
multiplying each of the plurality of sub-channels with the assigned separate value to generate a multiplied value for each of the plurality of sub-channels;
modulating the multiplied value of each of the plurality of sub-channels to a sub-carrier to generate a modulated signal for each of the two or more channels; and
simultaneously transmitting the modulated signal of each of the two or more channels.

19. An article of manufacture comprising a computer usable medium having computer readable program code means embodied therein for causing multi-carrier transmission of data, the computer readable program code means in said article of manufacture comprising computer readable program code means for causing a computer to effect the steps of claim 18.

20. An apparatus for multi-carrier transmission of data comprising:
an encoder unit that receives a stream of data and creates a plurality of complex values;
a de-multiplexer for assigning each of the plurality of complex values to one of a plurality of sub-channels which form one of two or more channels;
a multiplication unit for multiplying each of the plurality of sub-channels with a separate value to generate a multiplied value for each of the plurality of sub-channels;
a modulator for modulating the multiplied value of each of the plurality of sub-channels to a sub-carrier to generate a modulated signal for each of the two or more channels; and
a transmitter for simultaneously transmitting the modulated signal via an transmission antenna, each of the two or more channels has its assigned transmission antenna.

21. A computer program product comprising a computer usable medium having computer readable program code means embodied therein for causing multi-carrier transmission of data, the computer readable program code means in said computer program product comprising computer readable program code means for causing a computer to effect the functions of claim 20.
